(19) United States
(12) Patent Application Publication
(10) Pub. No.: US 2026/0276424 A1
(43) Pub. Date: Sep. 17, 2026

(54) Method for Determining and Displaying a Filling Level of a Press Container, Press Container, Computer Programme, and Computer-Readable Medium

(71) Applicant: Robert Bosch GmbH, Stuttgart (DE)

(72) Inventors: Thomas Gellner, Steinfeld (DE); Karin Tischler, Kleinostheim (DE); Maria Theresa Hartig, Burgsinn (DE); Oliver Gerhard, Zellingen (DE); Hardik Zalavadiya, Veitshoechheim (DE); Reiner Knoell, Burgsinn (DE)

(21) Appl. No.: 18/850,499

(22) PCT Filed: Mar. 27, 2023
(86) PCT No.: PCT/EP2023/057758

§ 371 Date: Sep. 24, 2024

(30) Foreign Application Priority Data
Mar. 30, 2022 (DE) 10 2022 203 138.5

(51) Int. Cl. G01F 23/00; B30B 15/00

(52) U.S. Cl. CPC G01F 23/00; B30B 15/0052

(57) ABSTRACT

A method for ascertaining and displaying a fill level of a press container is disclosed, in which at least one hydraulically actuatable press ram can be used to compact the contents in an interior of the press container. The method includes a) actuating the at least one hydraulic press ram; b) acquiring at least two operating parameters of the press ram during step a); c) evaluating the at least two operating parameters by comparing them with at least one previously known reference parameter; and d) displaying a fill level of the press container depending on the evaluation in step c). The disclosure also relates to an accordingly configured press container.

The present invention relates to methods for ascertaining and displaying a fill level of a press container, a press container, also referred to as a self-press container, as well as related computer programs and computer-readable media.

In the press container, the supplied material is compacted with at least one hydraulic press ram in the interior of the press container. Such press containers are used in particular for the collection, compaction and (temporary) storage of trash, recyclables and other bulky materials. It is possible for press containers to be temporarily provided locally and, if necessary, moved by vehicles.

It is desirable to obtain or provide information about the current fill level of the container. The fill level can in particular be used to indicate when further loading of the container is no longer possible/reasonable and/or when the full container should be emptied or replaced with an empty container.

Until now, there has been a rough classification of the filling. The displacement pressure of the pressing piston can be monitored during the pressing process by means of permanently set pressure switches. From this, a message is derived derived in a time-dependent manner, e.g. “75% full” or “100% full”. Accurate and continuous acquisition of the fill level is therefore not possible.

This characteristic variable is moreover dependent on many (environmental) parameters, which can lead to significant deviations and erratic data during the filling process or between individual pressing cycles.

There is a desire to provide a more accurate, more reliable and more flexible method for ascertaining and displaying the current fill level.

Based on this, the object of the present invention is to at least partially alleviate the problems described with reference to the prior art.

The intent is in particular to propose methods and devices that enable a more accurate, more reliable and/or continuous display of the current or future fill level of the press container.

This object is achieved by a method according to the features of the independent claim. Further advantageous embodiments of the invention are specified in the dependent claims. It should be noted that the features listed individually in the claims can be combined with one another in any technologically sensible manner and define further configurations of the invention. The features specified in the claims are moreover clarified and explained in more detail in the description and other preferred embodiments of the invention are shown.

A method for ascertaining and displaying a fill level of a press container contributes to this, wherein the press container is equipped with at least one hydraulically actuated or actuatable press ram with which the contents in an interior of the press container can be (moved and) compacted. The press container can substantially be designed as described above. It is in particular a press container that is configured to hold and compact materials, trash or waste. The press ram is driven or can be moved transversely, in particular forward and partly into and out of the interior, by a controllable hydrostatic transmission. The press container comprises a feed (open or closed), via which the contents or the material to be pressed can be placed in front of the press ram (in the retracted position). Activating the hydrostatic transmission or the associated hydraulic circuit moves the press ram into the interior and thus moves the contents into the container interior and possibly compacts it. Once compaction has been completed in the specified manner, the press ram can be retracted again by means of the hydrostatic transmission or the hydraulic circuit.

The here-proposed method comprises at least the following steps:
a) actuating the at least one hydraulic press ram,
b) acquiring at least two operating parameters of the press ram during step a);
c) evaluating the at least two operating parameters by comparing them with at least one previously known reference parameter;
d) displaying a fill level of the press container depending on the evaluation in step c).

It is generally possible for the method to be carried out with the sequence of steps a), b), c) and d) specified here. It is possible for the steps a), b), c) and d) to be carried out directly one after the other. However, it is also possible for the steps to overlap one another at least partly in terms of time or be carried out in parallel. It is possible for at least one of the steps b), c) or d) to be carried out multiple times, in particular during step a).

The actuation of the at least one press ram can be initiated manually or automatically. The press ram is moved forward or into the interior of the press container, preferably over at least part of a (maximum) travel distance. The actuation can include activating a hydraulic actuating element of the press ram. Step a) can be (automatically) terminated or canceled when a predetermined limit value of an operating parameter that is characteristic of the operation of the press ram is reached.

At least two operating parameters of the press ram are acquired at least over a plurality or a large number of times and/or a period of time during the actuation of the press ram. The acquisition of the at least two (different) operating parameters can take place at different and/or overlapping times/periods of time. The acquisition of the operating parameters is preferably carried out at very short intervals, i.e. at a high frequency. The acquired operating parameters are preferably not directly or linearly dependent on one another. The operating parameters are characteristic of the operation of the press ram, in particular with respect to the travel distance on the one hand and the (energetic) travel effort on the other. The acquisition of the operating parameter can include sensing and/or calculating and/or deriving manipulated variables.

One or both of the acquired operating parameters can be compared (directly) with at least one previously known reference parameter. It is possible for a separate reference parameter to be provided for each operating parameter. The reference parameters can be retrieved, set by the user, provided as needed and/or learned. It is possible for the evaluation of the operating parameters to be carried out sequentially or simultaneously. It is possible for the results of the evaluation to be stored and/or data-processed. The comparison can include a mathematical comparison of numerical values, signals or data. The reference parameter can in particular be configured in the form of a limit value and/or an (open or closed) range of values.

The two acquired operating parameters can be evaluated in relation to one another with respect to (predetermined) reference parameters. For example, it is possible for a first acquired value of the first operating parameter to be evaluated differently depending on the second acquired value of the second operating parameter, or to lead to a different result or a different display. One of the operating parameters is preferably evaluated taking into account the at least one other operating parameter and a display is generated from this evaluation.

It is further provided that a specific statement about the fill level of the press container is displayed depending on the evaluation. It is in particular possible for the result of the evaluation or a result derived (directly) from the evaluation, in particular the fill level itself, to be displayed. The display can be implemented on the press container itself. It is possible for the statement about the fill level to be forwarded and, for example, (additionally) displayed on a stationary or mobile display device.

The acquisition of the operating parameters, the evaluation of the operating parameters and display of the fill level are preferably carried out (automatically) with means of the press container.

In step b), the at least two operating parameters can be acquired continuously at least during a final time period of step a). It is possible for one or a plurality of the operating parameters to initially be acquired only sporadically and/or not at all. Once a predetermined operating situation of the press ram has been achieved, the acquisition intensity can be expanded or increased. This acquisition intensity should then preferably be maintained until the end of step a), in particular until the end of compaction and/or the retraction of the press ram.

The at least two operating parameters can include at least one of the following parameters: hydraulic pressure, pressing force (derived from said hydraulic pressure), ram travel. A first operating parameter is preferably selected from the group hydraulic pressure and pressing force, and a second operating parameter is the ram travel. The hydraulic pressure is a characteristic variable of the hydraulic circuit that drives or moves the press ram. The pressing force is in particular the force with which the press ram presses against the contents in the press container. Since hydraulic pressure and pressing force are clearly related to one another, they can preferably be acquired alternatively as one of the relevant operating parameters. The ram travel is in particular an operating parameter that indicates the current position or the distance traveled into the interior of the press container. The joint consideration of these two operating parameters makes it possible to evaluate which pressures/forces are present at which point of the ram travel.

It is possible for all steps b) to d) to be carried out only once at least one of the at least two operating parameters reaches a threshold value. For example, it is possible for the second operating parameter to also be acquired only once one of the operating parameters has reached the predetermined threshold value. It is possible for an evaluation to be carried out only once one or both operating parameters have reached a respective predetermined threshold value. It is possible for a display to be carried out only once the evaluation has reached a specific (further) threshold value. This in particular makes it possible to deliberately keep the computational effort low and thus also conserve a (local) power source or save energy.

At least one of the at least two operating parameters can be determined by means of sensors. In particular a hydraulic pressure and/or ram travel of the press ram can be acquired with a sensor. The (electronic) signals of the sensor relating to this operating parameter can be transmitted by wire or wirelessly to a control unit of the press container. These signals, which are characteristic of the operating parameters, can be processed or used directly for the method.

It is possible for step d) to allow a selection of differently energy-consuming displays depending on the evaluation in step c). It is possible for several display options to be provided, that in particular consume different amounts of energy (of a possibly local energy source) for the display. There may consequently be a choice of different displays, which can in particular include the use of different display devices and/or different types of displays (such as visualizations). The at least one display can be provided on the press container. It is possible for the press container to use its means to initiate a display at a remote location, such as a monitor, a mobile device or on the Internet. The specific selection can be based on the result of the evaluation. It is thus possible to set limit values to send a notification to users. It can, for example, be inferred that there is an elevated fill level, a longer service life and thus also a greater depletion of the local (finite) power source.

In step d), further (environmental) parameters can be included, wherein adjusted information relating to the fill level of the press container is ascertained and displayed (at least continuously, as needed and/or upon specific request). Environmental parameters can in particular include parameters that relate to the contents (the material to be pressed) and/or the routine for adding contents to the press container. The environmental parameters can, for instance, be used to interpret the result based (solely) on the operating parameters. It is possible for the parameters to be included to set threshold values, limit values and/or reference values. It is possible for the parameters to be used to determine an expected result from step c), which is compared to the ascertained result and/or evaluated.

Tracking or interpreting the results from step c) and/or including parameters can make it possible to anticipate or determine a future fill level in good time. The fill level or the development of the fill level at a future point in time can thus be forecast ahead of time.

A particularly preferred embodiment of the method includes determining the fill level of the press container based on a hydraulic pressure measurement and the press position during the filling process. By observing the characteristic pressure progression during the filling process, the fill level can be acquired continuously and output with a higher resolution. The acquisition of the press position can be evaluated as a real measured value or a mathematically modeled value as a condition for the fill level of the press.

The continuous acquisition enables better planning and utilization of the container capacity.

The user can define different types of information output or measures depending on the fill level. This information is also suitable for optimizing the supply of power via batteries and solar or mains supply.

This makes it possible to identify errors or special use cases; for example to warn the user of damage or to avoid premature collection. The acquisition of the fill level can be made even more precise by using given material data.

It is possible for parameters that allow routines and/or processes to be identified to be evaluated. Artificial intelligence or machine learning can be used to identify typical filling processes in terms of timing, filling materials and/or filling quantities. This information can be used for improved or predictive ascertainment and display of the fill level. This enables a prediction of the filling mass or material in addition to the fill level.

According to a further aspect, a press container comprising at least one hydraulic press ram is proposed. The press ram can be used to compact the contents in an interior of the press container. A display for the fill level of the press container is provided as well. The press container also comprises means that are suitable for (at least partly) carrying out the steps of the here-proposed method.

The explanations relating to the method can also be used to characterize the press container, the display, and/or the means.

The at least one display can be provided on the press container. It is possible for the press container to use its means to initiate a display at a remote location, such as a monitor and/or a mobile device.

Also proposed is a computer program, which comprises instructions that cause the press container to carry out the steps of a here-proposed method. It is possible for a computer-readable medium on which the computer program is stored to be provided.

The press container can have a control unit with a predetermined computing and/or storage capacity, in particular comprising a microcontroller on which the computer program is stored or installed and/or on which the computer program can be executed.

The means can also include sensors for acquiring the operating parameters.

The press container can further be designed with a radio device comprising an antenna in order to (wirelessly) send or receive data, results, parameters, notifications, etc. A (secure) radio communication with a cloud can be set up.

The invention and the technical environment will be explained in more detail in the following with reference to the figures. It should be noted that the figures show a particularly preferred design variant of the invention. The invention is not limited to this, however. In the figures, identical components are provided with the same reference signs. The figures show schematically and as an example:

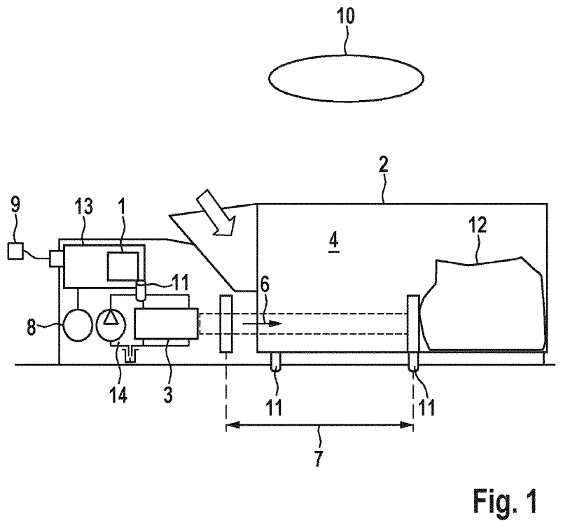

FIG. 1: a design variant of a press container,

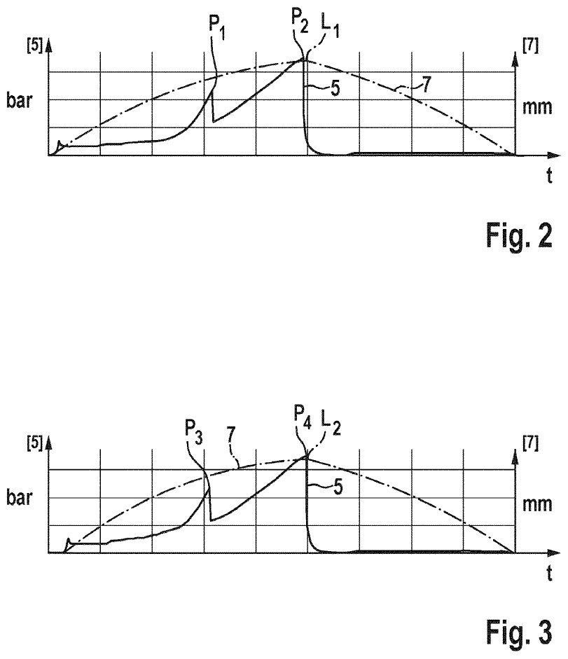

FIG. 2: a first diagram,

FIG. 3: a further diagram,

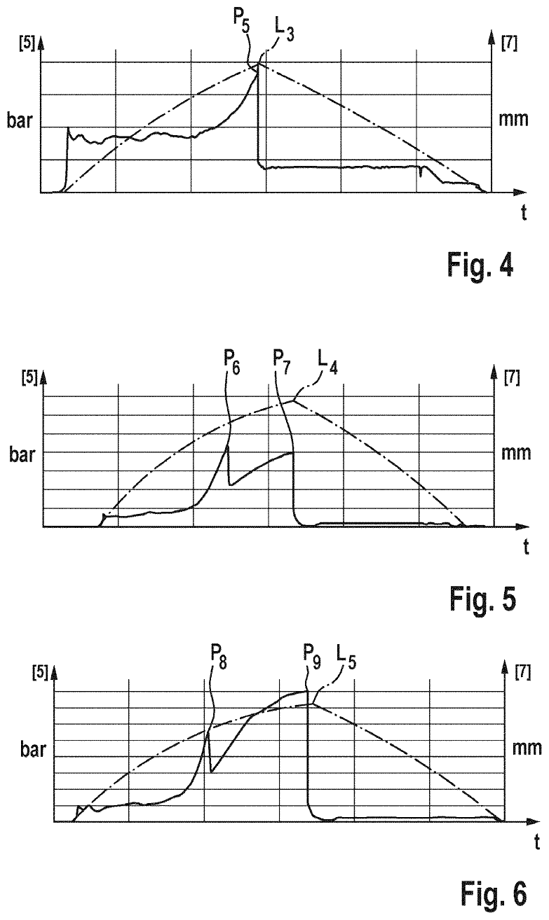

FIG. 4: a first diagram illustrating a situation for an empty paper container,

FIG. 5: a second diagram illustrating a situation for a half-full paper container

FIG. 6: a third diagram illustrating a situation for a full paper container.

FIG. 1 shows an example of a press container 2 comprising a hydraulic press ram 3 with which the contents 12 (such as, trash) can be compacted in an interior 4 of the press container 2 with a predetermined pressing force 6. The press container 2 can be configured as a movable unit, in which case a correspondingly limited interior 4 for a maximum predetermined quantity of the contents 12 is provided.

The material or trash can be placed into the press container 2 (e.g. along the white arrow via a hatch). The hydraulic press ram 3 can be moved in the interior 4 along a ram travel 7, wherein the contents 12 are compacted against the opposite container wall when as the press ram moves into the interior 4.

The drive and the control unit 13 for the hydraulic press ram 3 are provided on the outside, but adjacent to the interior 4, in a housing. The drive comprises a controllable hydraulic circuit 14. The control unit 13 can set and monitor the operation of the press ram 3 or the hydraulic circuit 14. For this purpose, it can be connected to sensors 11 that are assigned to the hydraulic circuit 14, the press ram 3 and/or the interior 4, for example.

The control unit 13 is further designed with an antenna 9 for establishing a radio link to a cloud 10. As a power source, the press container 2 comprises a battery 8; for example to be operated with solar energy or from the power grid.

A display 1 for making known (in particular visualizing) the (current or possibly future) fill level of the press container 2 is provided as well.

The press container 2 with its means is configured such that it can carry out at least the steps of the following method:
a) actuating the at least one hydraulic press ram 3,
b) acquiring at least two operating parameters of the hydraulic press ram 3 during step a);
c) evaluating the at least two operating parameters by comparing them with at least one previously known reference parameter;
d) displaying a fill level of the press container 2 depending on the evaluation in step c).

FIG. 2 and FIG. 3 illustrate the method, in particular steps b) and c), in a specific embodiment. It should be noted that the shown progressions are examples. The pressure progression relates here in particular to the pressure at the piston rod of the hydraulically operated press ram.

The progressions of the hydraulic pressure 5 and the ram travel 7 are shown over time, in particular over the cycle of the hydraulic press ram 3 moving in and moving back out.

FIG. 2 illustrates a monitored or recorded progression of the hydraulic pressure 5 over time t. It can be seen that the hydraulic pressure 5 is initially approximately constant over time and the ram travel 7 and then increases to a value P1. At this point in time, there was a (possibly automatic) switchover from a rapid traverse setting of the ram 3 to a pressing traverse setting. In a rapid traverse setting, the ram 3 can be moved with lower pressure and higher speed to quickly move the material to be pressed into the press chamber. In a pressing traverse setting, the ram 3 can be moved with higher pressure and lower speed to press the material to be pressed into the press chamber. After a local, brief drop in pressure, the pressure increases further to a (maximum) value P2 (here 181 bar, for example), in which case a (maximum) value for the ram travel L1 (here 1,711 mm, for example) can be detected at the same time. From this pair of values, it can be deduced that the fill level is approximately 95%.

FIG. 3 illustrates another pressing process, in which new material to be pressed has been added to the press container 2 in the meantime. The progression of the hydraulic pressure 5 is similar to that of FIG. 2, wherein here too there is a switchover from a rapid traverse setting of the ram 3 to a pressing traverse setting at the pressure value P3. After a local, brief drop in pressure, the pressure increases further to a (maximum) value P4 (here likewise 181 bar, for example), in which case a (maximum) value for the ram travel L2 (here 1,687 mm, for example) can be detected at the same time. From this pair of values, it can be deduced that the fill level is approximately 100%.

Considering the respective situation at the maximum value P2 or P4 of the two progressions, it can be observed that the (approximately equal) maximum value of the hydraulic pressure 5 occurs at different ram travels 7. The hydraulic pressure 5 can be considered at a specific reference value, for example, and the associated ram travel 7 can then be evaluated in order to make a decision about the display after step c).

It is obvious that the progressions depend in particular on the properties of the material to be pressed (paperboard, trash, bulky trash, etc.) and the design of the press hydraulics. The value of the limit or maximum pressure is not characteristic in and of itself because it depends on the setting of the hydraulic system. It depends in particular on the setting of the machine (setting of the pressure relief valve to protect the components from overloading) and increasingly on the pressing of the material to be pressed (bulky trash behaves differently than paper when pressed). The stated limit pressure is relevant in this example. For other types of presses, which may have a lower pressure set at the pressure relief valve due to the hydraulic system, other limit pressures may be relevant.

FIG. 4 to 6 illustrate other situations using the example of the relationship between the progression of the hydraulic pressure 5 and the ram travel 7 to ascertain the respective fill level of a (paperboard/paper) container.

Initially, i.e. with a (practically) empty press container 2, the material to be pressed (here paper) is merely pushed into the interior 4 or press chamber. As can be seen from FIG. 4, the pressure level overall remains relatively (constant and) low until shortly before the maximum ram travel 7 is reached (see P5 here below 55 bar). Due to the low pressure P5 at the end of the ram travel 7 (see L3; here approximately 1,900 mm, for example), the hydraulic press ram 3 moves back to the starting position and the pressure does not increase to the (previously known) maximum pressure, in particular in order to save energy.

After several filling processes, a progression as illustrated in FIG. 5 can then be observed in the same (approximately half-full) press container. Here it is provided that the hydraulic system automatically switches the hydraulic press ram 7 from rapid traverse to pressing traverse when the predetermined pressure P6 (here 110 bar) is achieved (generally, however, operation with different modes such as rapid traverse and pressing traverse is not required). As the process continues, it can be seen that a (compared to P5) higher pressure P7 (here approximately 105 bar) is achieved or observed when the end position is reached (see L4; corresponds to L3 in FIG. 4), but an even higher pressure value P6 was ascertained previously at a lower or earlier position (e.g. at approximately 1600 mm) of the hydraulic press ram 7. From this it can be concluded that the press container is approximately 50% full.

With a full press container 2, the end position of the ram travel 7 is no longer reached when the predetermined maximum pressure (here P9, approximately 180 bar, for example) is achieved see FIG. 6. In this situation, the predetermined maximum pressure P9 is already achieved at a position L5, which here corresponds to a ram travel 7 of 1711 mm, for example. Moreover, from the fact that the pressure P8 at the changeover point is lower than the ascertained maximum pressure P9, it can be concluded that the press container is full.

In this way, the problems described with reference to the prior art have been alleviated. In particular methods and devices have been specified that enable a more accurate, more reliable and/or continuous display 1 of the current fill level of the press container 2.

### LIST OF REFERENCE SIGNS

1 Display
2 Press container
3 Hydraulic press ram
4 Interior
5 Hydraulic pressure (Pi)
6 Pressing force
7 Ram travel (Li)
8 Battery
9 Antenna
10 Cloud
11 Sensor
12 Content
13 Control unit
14 Hydraulic circuit

1. A method for ascertaining and displaying a fill level of a press container in which at least one hydraulically actuatable press ram can be used to compact the contents in an interior of the press container, comprising:
a) actuating the at least one hydraulic press ram;
b) acquiring at least two operating parameters of the hydraulic press ram during step a);
c) evaluating the at least two operating parameters by comparing them with at least one previously known reference parameter; and
d) displaying a fill level of the press container depending on the evaluation in step c).

2. The method according to claim 1, wherein step b) includes continuously acquiring the at least two operating parameters at least during a final time period of step a).

3. The method according to claim 1, wherein the at least two operating parameters include at least one of the following parameters: hydraulic pressure, pressing force, and ram travel.

4. The method according to claim 1, wherein all steps b) to d) are carried out only once until at least one of the at least two operating parameters reaches a threshold value.

5. The method according to claim 1, wherein at least one of the at least two operating parameters is determined by way of sensors.

6. The method according to claim 1, wherein step d) allows a selection of differently energy-consuming displays depending on the evaluation in step c).

7. The method according to claim 1, wherein step d) includes further parameters and displays adjusted information relating to the fill level of the press container.

8. A press container, comprising:
at least one hydraulic press ram configured to be used to compact the contents in an interior of the press container,
a display for the fill level of the press container, and
means suitable for carrying out the steps of a method according to claim 1.

9. A computer program comprising instructions that cause a press container to carry out the steps of a method according to claim 1.

10. A computer-readable medium on which the computer program according to claim 9 is stored.
